(19) United States
(12) Patent Application Publication
(10) Pub. No.: US 2010/0059155 A1
(43) Pub. Date: Mar. 11, 2010

(54) PNEUMATIC TIRE HAVING A HIGH STRENGTH/HIGH MODULUS POLYVINYL ALCOHOL CARCASS PLY

(76) Inventors: Walter Kevin Westgate, Uniontown, OH (US); Derek Shuttleworth, Medina, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/206,765

(22) Filed: Sep. 9, 2008

(51) Int. Cl. B60C 11/00; B60C 9/00

(52) U.S. Cl. 152/209.1; 152/451

(57) ABSTRACT

A light weight pneumatic tire in accordance with the present invention includes a pair of parallel annular beads, a carcass ply comprising a polyvinyl alcohol crosslinked raw cord, a belt reinforcement structure disposed radially outward of the carcass ply in a crown area of the tire, a tread disposed radially outward of the belt reinforcement structure, and a pair of sidewalls disposed between the tread and the pair of beads. The polyvinyl alcohol crosslinked raw cord has a weight in the range of 1500 dtex to 2500 dtex.

### TECHNICAL FIELD

The present invention relates to a pneumatic tire having a carcass reinforced by a polyvinyl alcohol ply.

### BACKGROUND OF THE INVENTION

It is a continuing goal in tire development to reduce tire weight by limiting the amount of material in the tire without diminishing performance characteristics. Conventional attempts have been made to reduce the number of carcass plies used in passenger tires from two plies to one ply by using larger and stronger carcass ply reinforcement cords. Although such “mono-ply” tires perform as well as two ply tires in many respects, mono-ply tires may incur unacceptable distortion in areas of the tire affected by overlap splices. In the conventional two-ply tire, the plies offset each other and such distortion is not a performance detriment. Thus, production of a mono-ply tire with the inherent, lighter weight advantage and, also, minimal distortions due to a higher strength mono-ply would be desirable to tire manufacturers and consumers.

### SUMMARY OF INVENTION

A light weight pneumatic tire in accordance with the present invention includes a pair of parallel annular beads, a carcass ply comprising a crosslinked raw cord, a belt reinforcement structure disposed radially outward of the carcass ply in a crown area of the tire, a tread disposed radially outward of the belt reinforcement structure, and a pair of sidewalls disposed between the tread and the pair of beads. The polyvinyl alcohol crosslinked raw cord has a weight in the range of 1500 dtex to 2500 dtex.

In one aspect of the tire, the polyvinyl alcohol crosslinked raw cord has a degree of polymerization of 1,000-7,000 and a degree of saponification of more than 97 mol %. The polyvinyl alcohol is dissolved in dimethyl sulfoxide to form a solution. The solution is spun to form an undrawn yarn. The undrawn yarn is drawn to a high ratio and is thermally treated to form a drawn yarn. The drawn yarn is twisted and plied to form a raw cord. The raw cord is wound and crosslinked in an aqueous crosslinking solution. The aqueous crosslinking solution has an aromatic aldehyde compound, an acid catalyst, and alcohol to form the crosslinked raw cord.

In another aspect of the tire, the aqueous cross linking solution comprises methanol.

In still another aspect of the tire, the alcohol of the aqueous crosslinking solution contains 1-30% weight.

In yet another aspect of the tire, the aromatic aldehyde compound is 0.1-5.0% weight.

In still another aspect of the tire, the acid catalyst is acetic acid.

In yet another aspect of the tire, the crosslinked raw cord is dipped in an adhesive. The adhesive may be resorcinol formaldehyde latex.

In still another aspect of the tire, the crosslinked raw cord has a construction of 1670 dtex/½. The crosslinked raw cord may further have a 472Z×472S twist.

In yet another aspect of the tire, the crosslinked raw cord has a construction of 2200 dtex/½. The crosslinked raw cord may further have a 336Z×336S twist.

### BRIEF DESCRIPTION OF THE DRAWINGS

FIG. 1 is a schematic sectional view of an example tire for use with the present invention.

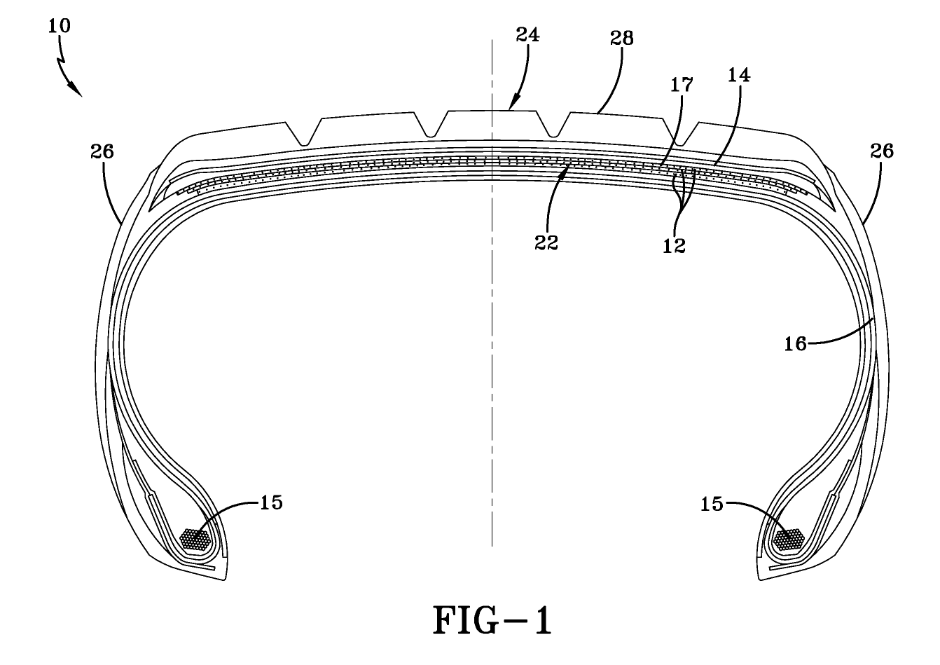

### DEFINITIONS AS USED BY THE BELOW DESCRIPTION

As used herein and in the claims:

“Axial” and “axially” are used herein to refer to lines or directions that are parallel to the axis of rotation of the tire.

“Bead” means that part of the tire comprising an annular tensile member wrapped by ply cords and shaped, with our without other reinforcement elements such as flippers, chippers, apexes, toe guards and chafers, to fit the design of the tire rim.

“Belt structure” means at least two layers of plies of parallel cords, woven or unwoven, underlying the tread, unanchored to the bead, and having both left and right cord angles in the range from about 17 to about 27 degrees with respect to the equatorial plane (EP) of the tire.

“Carcass” means the tire structure apart from the belt structure, the tread and the undertread, but including the beads. The carcass ply includes reinforcing cords embedded in an elastomeric substance and that these components are considered to be a single entity. The “main portion of the carcass ply” means the portion of the carcass ply which extends between the bead cores.

“Cord” means one or more of the reinforcement elements, formed by one or more filaments/wires which may or may not be twisted or otherwise formed and which may further include strands that may or may not be also so formed.

“Crown” means that portion of the tire within the width limits of the tire tread.

“Equatorial plane (EP)” means the plane perpendicular to the tire's axis of rotation and passing through the center of the tire's tread.

“Load Range” means load and inflation limits for a given tire used in a specific type of service as defined by tables in The Tire and Rim Association, Inc. 1995 Year Book.

“Ply” means a continuous layer of rubber-coated parallel filaments.

“Pneumatic tire” means a laminated mechanical device of generally toroidal shape (usually an open-torous) having beads, a carcass ply and a tread.

“Prefix Letters” means those identifications used and defined in The Tire and Rim Association, Inc. 1995 Year Book.

“Radial” and “radially” are used to mean directions radially perpendicular from the axis of rotation through the tire.

“Radial-ply tire” means a belted or circumferentially restricted pneumatic tire in which the carcass ply reinforcements which extend from bead to bead are laid at angles between 75 degrees and 105 degrees with respect to the equatorial plane of the tire.

“Rivet” means the open space between cords in a layer.

“Section width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Tensile strength” is determined by ASTM A370-92 as applied to steel wire product.

### DETAILED DESCRIPTION OF AN EXAMPLE EMBODIMENT

An example tire 10 for use with the present invention includes a carcass ply 16 wrapped around a pair of parallel annular beads 15, a belt reinforcement structure 22 disposed radially outward of the carcass ply 16 in a crown portion 24 of the tire, a tread 28 disposed radially outward of the belt reinforcement structure 22, and two sidewalls 26 interconnecting the tread 28 and the beads 15. The belt reinforcement structure 22 may vary as required by the size and design of the particular tire. The example tire 10 has a belt reinforcement structure 22 with three belts 12, a gum rubber cushion layer 17, and an overlay 14.

A conventional polyethylene terephthalate (PET) carcass ply cord has heightened sensitivity to twisting and treating conditions. By increasing the tension on the conventional cord during dipping in an adhesive (i.e., a resorcinol formaldehyde (RFL) latex adhesive) along with proper twist multiplier, the treated tenacity of the conventional cord may increase. This may also yield a more uniform (i.e. more reproducible) PET treated cord tensile properties.

A polyvinyl alcohol (PVA) carcass ply 16, in accordance with the present invention, may provide at least a 40% increase of in-rubber modulus/strength over the conventional PEN carcass ply and other conventional carcass plies. Further, the PVA carcass ply 16 may be utilized in a light tire carcass to provide a significant reduction in tire weight while not only maintaining, but improving, tire uniformity over conventional tire designs and reinforcement materials. Cords of the PVA carcass ply 16 may range from 1500 dtex to 2500 dtex. One example PVA carcass ply 16 may have a 1670 dtex/½ construction with a 472Z×472S twist. Another stronger example PVA carcass ply 16 may have a 2200 dtex/½ construction a 335Z×335S twist.

Below, test results of a 2200/½ dTex PVA construction with 8.5×8.5 turns per inch are compared to conventional large ply materials—2200/½ Polyester and 2100/½ Nylon. As stated above, significant cost may be removed from tires by reducing the number of plies in the tires while maintaining the ply strength. With the same base material, such as polyester, this may be accomplished by using more ply material, either by increasing ends per inch in the fabric or by increasing the gauge/denier/dtex.

For example, tires constructed with 1670/½ polyester in two plies, a limitation is reached on the amount of polyester material that can be added to move to one ply. Challenges occur in the balance of epi, rivet, gauge, and cost. A new approach is to use a base material with higher strength, such as PVA. Table 1 below shows sample calculations for PVA solutions.

TABLE 1
PLY STRENGTH AND RIVET CALCULATIONS

| | Polyester | | Polyester | |
|---|---|---|---|---|
| | 1100/1/2 - 2 ply | PVA | 1100/1/2 - 2 ply | PVA |
| | TC28HA | 1670/1/2 - 1 ply | TC35HA | 2200/1/2 - 1 ply |
| Cord Tensile Strength (N) | 142 | 296 | 142 | 360 |
| Ends Per Inch (EPI) | 28 | 27 | 35 | 28 |
| Cord Gauge (in) | 0.022 | 0.026 | 0.022 | 0.031 |
| Inch Strength (N) | 7952 | 7992 | 9940 | 10080 |
| Rivet (in) | 0.014 | 0.011 | 0.007 | 0.005 |
| | Polyester | | Polyester | |
| | 1670/1/2 - 2 ply | PVA | 2200/1/2 - 2 ply | PVA |
| | TV28HP | 2200/1/3 - 1 ply | TM27HB | 1670/1/2 - 2 ply |
| Cord Tensile Strength (N) | 215 | 500 | 285 | 296 |
| Ends Per Inch (EPI) | 28 | 24 | 27 | 26 |
| Cord Gauge (in) | 0.026 | 0.034 | 0.031 | 0.026 |
| Inch Strength (N) | 12040 | 12000 | 15390 | 15392 |
| Rivet (in) | 0.01 | 0.008 | 0.006 | 0.012 |

In general, PVA loses tensile strength during Heat Resistance and Thermal Stability testing. Performance is similar to Nylon 6,6. Additionally, PVA loses LASE when cured in rubber as illustrated by the Heat Degradation and Unflexed Dynamic Samples.

However, PVA has better dimensional stability than Polyester or Nylon as seen in creep and shrinkage testing. Further, PVA has marginal fatigue resistance at 53% retained on the half-inch spindle flex fatigue test. Also, PVA has satisfactory adhesion both in static and dynamic tests and thermal stability properties similar to Nylon 6,6. Thus, PVA may advantageously replace polyester two ply applications with a one ply PVA application.

A 2200/½ greige cord sample at 8.5×8.5 turns per inch twist has been evaluated. The results are shown in Table 2 below, comparing the sample with 2100/½ Nylon 6,6 and 2200/½ polyester.

TABLE 2
PVA, PET, AND NYLON SUMMARY

| | A PVA | | Reference | Reference |
|---|---|---|---|---|
| | 2200/1/2 | | PET | Nylon |
| | 8.5 × 8.5 | | 2200/1/2 | 2100/1/2 |
| Material | Dipped | Greige | 8.5 × 8.5 | 8 × 8 |
| Tensile 30282 | | | | |
| Max Load (N) | 345 | 357 | 278 | 345 |
| Max Strain (%) | 9.2 | 13.5 | 17.7 | 27 |
| LASE @ 5% (N) | 175 | 100 | 56 | 34 |
| Tenacity (cN/Tex) | 68.20 | | | |
| Free Shrink Tensile 30289 | | | | |
| Max Load (N) | 343 | 357 | | |
| Max Strain (%) | 10.2 | 12.4 | | |
| LASE @ 5% (N) | 164 | 125 | 50 | |
| Cable Twist (tpi) 31710 | 8.6 | 8.7 × 7.8 | 8.5 × 8.5 | |
| Linear Density (dTex)30410 | 5059 | | | |
| Gauge (mm. in) 30810, 20810 | 0.033 | | | |
| Creep 3.5# (%) 31460 | 0.39 | | 0.55 | |
| Dip Pick-up (%) 60640 | 8.2 | | | |
| Testrite Shrinkage 31420, 21420, 31421 | | | | |
| Shrinkage (%) | 1.1 | | 2 | |
| Shrink Force (N) | 5.8 | | | |
| L/S Ration | 162 | | | |
| Heat Resistance 30910 | | | | |
| Max Load (N) | 295 | | | 318 |
| Max Strain (%) | 9 | | | 32 |
| LASE @ 5% (N) | 166 | | | 23 |
| Thermal Stability 30940 | | | | |
| Max Load (N) | 143 | | 255 | 155 |
| Max Strain (%) | 6 | | | 19 |
| LASE @ 5% (N) | 118 | | | 23 |
| Ammoniolysis 30970 | | | | |
| Max Load; (N) | 338 | | 200 | |
| Max Strain (%) | 9 | | | |
| LASE @ 5% (N) | 186 | | | |
| Heat Degradation 30961 | | | | |
| Max Load (N) | 351 | | | |
| Max Strain (%) | 18 | | | |
| LASE @ 5% (N) | 61 | | | |
| SEAT Adhesion F168A (N) 5160 | 130 | | | |
| Hot-U Adhesion CW921 (N) 50140 | 181 | | | |
| Static Adhesion (N) | Adh Force | Coverage | | |
| F168A, 13′ @ 340 50131 | 122 | 5.0 | 120 (5) | |
| F168A, 6′ @ 340 50131 | 144 | 4.5 | | |
| F168A, 10′ @ 360 50133 | 134 | 5.0 | | |
| F747M 13′ @ 340 50136 | 168 | 4.5 | | |

| Dynamic Flex | Unflexed | Flexed | % Retained | |
|---|---|---|---|---|
| Dynamic Flex F168A 14′ @ 340 F., | | | | |
| 28 EPI, 1″ 2.5 hr RT 50221 | | | | |
| Adhesion (N) | 159 | 144 | 90 | 110/97 |
| Tensile 50201 | | | 5 | |
| Max Load (N) | 361 | 359 | 99 | |
| Max Strain (%) | 12 | 12 | 103 | |
| LASE 5% (N) | 130 | 118 | 91 | |
| Dynamic Flex F168A 14′ @ 340 F., | | | | |
| 28 EPI, 0.75″, 2.5 hr RT 50222 | | | | |
| Adhesion (N) | 141 | 130 | 92 | |
| Tensile 50202 | | | 5 | |
| Max Load (N) | 354 | 316 | 89 | |
| Max Strain (%) | 12 | 11 | 95 | |
| LASE 5% (N) | 139 | 120 | 86 | |
| Dynamic Flex 168A 14′ @ 340 F., | | | | |
| 28 EPI, 0.5″, 2.5 hr RT 50223 | | | | |
| Adhesion (N) | 136 | 115 | 85 | 290/200 |
| Tensile 50203 | | | 5 | |
| Max Load (N) | 358 | 189 | 53 | |
| Max Strain (%) | 12 | 8 | 63 | |
| LASE 5% (N) | 118 | 110 | 93 | |
| Dynamic Flex F747M, 14′ @ 340 F., | | | | |
| 28 EPI, 1″, 2.5 hr RT 50224 | | | | |
| Adhesion (N) | 132 | 127 | 96 | |
| Tensile 50204 | | | 4.5 | |
| Max Load (N) | 351 | 346 | 99 | |
| Max Strain (%) | 11 | 12 | 105 | |
| LASE 5% (N) | 142 | 130 | 92 | |

The PVA thus has a tenacity value similar to Nylon, but lower elongation compared to both Nylon and Polyester. Thermal resistance of the cord in-rubber and by itself shows deterioration of tensile properties, similar to Nylon. This can be seen by the drop in tensile properties for Heat Resistance and Thermal Stability tests. Also, the in-rubber Heat Degradation test shows a loss of LASE and an increase in elongation. This can also be seen in the unflexed tensile values for the Dynamic Flex test. Chemical stability as measured by Amoniolysis is good for PVA. Adhesion is good for PVA as measured by SEAT, Hot-U, Static, and Dynamic Flex adhesion tests. Flex fatigue retained tensile show a reduction in tensile strength to 53% of the original strength for the Dynamic Flex using a ½ inch spindle. This is just above the minimum requirement of 50%.

Currently, conventional PVA materials provide little to no opportunity for tire reinforcement usage due to poor thermal resistance. However, in accordance with the present invention, the PVA carcass ply 16 may achieve excellent “in tire” performance through a higher molecular weight PVA. The PVA carcass ply 16 comprises a conventional molecular weight polymer coupled with a unique post-processing procedure (including particular adhesive/processing technology) to provide the above mentioned 40% increase in strength and modulus over conventional carcass plies, while still maintaining thermal/chemical/mechanical resistance.

The material for the PVA carcass ply 16 may begin as a crosslinked polyvinyl alcohol (PVA) fiber. The crosslinked PVA fiber, in which the PVA resin has a degree of polymerization of more than 1,000 and a degree of saponification of more than 97.0 mol %, may be dissolved in dimethyl sulfoxide (DMSO) to form a PVA solution. The PVA solution is subjected to dry and wet gel spinning with methanol as a coagulation solution, drawn, and thermally treated. The resultant PVA drawn 500-3,000 denier yarn is twisted to produce a cabling yarn. The cabling yarn is plied into a 2-ply or 3-ply yarn to produce a raw cord. The raw cord is wound on a bobbin for crosslinking and crosslinked in an aqueous crosslinking solution containing an aromatic aldehyde compound and acid catalyst. The raw cord demonstrates superior strength and modulus to conventional cords of polyamide, polyester, PEN, or polyacrylonitrile. Further, the raw cord has excellent adhesion, water dispersibility, alkaline resistance, and chemical resistance.

The crosslinking solution is preferably an aldehyde compound capable of crosslinking with the hydroxy group of PVA. The aldehyde compound preferably has two or more aldehyde groups in order to increase crosslinking efficiency. The aldehyde compound is more preferably an aromatic compound which infiltrates only into the non-crystalline region of the PVA fiber. Examples of this aromatic aldehyde compound may include terephthaldicarboxaldehyde (TDA), isophthaldicarboxaldehyde (IDA) and naphthaldicarboxaldehyde (NDA), and/or a mixture of two or more thereof.

The key feature of the aromatic aldehyde is infiltration only into the non-crystalline region of the drawn yarn. Since the aromatic aldehyde mainly infiltrates into the non-crystalline region of the yarn, the tenacity of the drawn yarn may be maintained even though crosslinked.

In general, a crosslinking agent is dissolved in an organic solvent in an extraction process in order for the crosslinking agent to infiltrate the fiber. However, this causes a reduction in thermal drawability at high temperature, above 200 degrees Celsius. Thus, the drawn yarn does not have sufficient hot water resistance and fatigue resistance. Organic solvent recovery also becomes difficult.

In order to increase crosslinking efficiency and to prevent fiber damage, the twisted PVA raw cord, for use with the present invention, is crosslinked after it is infiltrated with the crosslinker. This produces a high-strength PVA fiber having a hot water resistance above 130 degrees Celsius and a fatigue resistance of at least 80%. Further, the raw cord is crosslinked in a crosslinking solution containing an aromatic aldehyde compound and an acid catalyst, while adding alcohol to the aqueous crosslinking solution. The addition of alcohol to the crosslinking solution significantly prevents reduction of tenacity.

One example of production of the PVA fiber for use with the present invention is now described. PVA has a degree of polymerization of about 1,000-7,000, and preferably 1,500-4,000. At a degree of polymerization lower than 1,000, fiber formation is difficult. At a degree of polymerization higher than 7,000, a high viscosity reduces spinning processability. Since it is desirable that the PVA fibers have hot water resistance, PVA with a saponification degree of more than 97.0 mol % is used. Ethylene glycol, glycerin, and DMSO may be used as the organic solvent. However, DMSO is most suitable because of its highest solubility in PVA. The DMSO is preferably purified to a water content of less than several tens ppm before use.

The concentration of the PVA dope is adjusted such that its viscosity is preferably in a range of 50-4,000 poise, and more preferably 500-3,000 poise in order to obtain excellent physical properties. At a viscosity below 50 poise, it is difficult to form the PVA dope into a fiber, and at a viscosity above 4,000 poise, fiber spinnability is reduced.

A coagulation bath may have a temperature of −30 to 30.degrees Celsius for spinning, and preferably −10 to 10 degrees Celsius for the formation of a uniform gel. If the temperature of the coagulation bath is below −30 degrees Celsius, spinning PVA may freeze. If the temperature of the coagulation bath is higher than 30 degree Celsius, gel formation becomes impossible so that spinnability will be reduced.

The PVA fiber may be dry spun, wet spun, or dry and wet spun, but dry and wet spinning is preferred. The air-gap in the dry and wet spinning technique may be 5-200 mm for production of a PVA filament, but a narrow air-gap of 5-50 mm is preferred. At an air-gap below 5 mm, workability is reduced. At an air-gap above 200 mm, crystallinity is greater than gelling making thermal drawing at high draw ratio impossible. Also, fusion between fibers on a nozzle section may reduce productivity.

Heating methods during the drawing process may include hot air heating or roller heating. In roller heating, a filament contacts the roller surface such that the fiber surface may be damaged. Thus, hot air heating is typically more effective for the production of the high-strength PVA fiber. The heating temperature may be 140-250 degrees Celsius, and preferably 160-230 degrees Celsius. At a heating temperature below 140 degrees Celsius, molecular chains will not sufficiently move, thus making thermal drawing at high draw ratio impossible. Above 250 degrees Celsius, PVA may decompose causing a reduction in physical properties.

Since high strength and fatigue resistance are desirable for the carcass ply 16, the PVA drawn yarn is twisted to produce the raw cord. Generally, for twisting synthetic fibers, an increase in twist number will result in a reduction in tenacity, but an increase in fatigue resistance. Thus, selecting suitable a twist number according to the purpose of use is very important. For example, a 1500 d/2p tire cord for the carcass ply 16 may be twisted to 300-500 TPM (turns per meter) before use. To enhance hot water resistance and fatigue resistance, the twisted PVA raw cord is crosslinked by the addition of a crosslinker.

To infiltrate the crosslinker only into the non-crystalline region of the PVA fiber drawn to high draw ratio, the aromatic aldehyde is used as the crosslinker, as described above. The aromatic aldehyde compound is preferably terephthaldicarboxaldehyde (TDA). The crosslinking compound is used at the amount of 0.1-5.0 wt % relative to a fiber, and preferably 0.5-2.0 wt %. If it is used at the amount of less than 0.1 wt %, an insufficient heat-water resistance below 130 degrees Celsius will occur. If it is used at the amount of more than 5.0 wt %, tenacity will be reduced.

To react the crosslinking compound with the OH group of PVA, an acid catalyst is required in an aqueous crosslinking solution. Although acids, such as sulfuric acid or acetic acid, may be used as the acid catalyst, acetic acid is preferable in view of reaction rate adjustment and stability. The acid catalyst is preferably used at the amount of 5-30 wt % relative to the aqueous crosslinking solution. If the acid catalyst is used at less than 5 wt %, crosslinking reaction will progress too slowly. If it is used at more than 30 wt %, removal of the acid catalyst will be difficult in the water-washing process after reaction. The addition of alcohol to the crosslinking solution significantly prevents reduction in tenacity after crosslinking.

Examples of preferred alcohols, which are added to the aqueous crosslinking solution, may include methanol, ethanol, propanol and/or butanol. Methanol is preferred. The alcohol is added at the amount of 1-30 wt % relative to the aqueous cros slinking solution. At less than 1 wt %, a great reduction in tenacity during crosslinking will make use for high-tenacity tire cord difficult. At more than 30 wt %, cost will increase and crosslinking will progress at a too slow rate.

As stated above, the polyvinyl alcohol drawn yarn is plied into a 2-ply or 3-ply yarn to produce a raw cord wound on a bobbin for crosslinking. Then, the wound raw cord is crosslinked by dipping it into the crosslinking solution. To infiltrate the crosslinking compound into the non-crystalline region of a PVA fiber with high crystallinity, a method may be used in which the reaction solution is heated to 50 degrees Celsius. The heated reaction solution increases the activity of the crosslinking compound. The reactor may also be pressurized beforehand. Crosslinking time may vary depending on the crosslinking compound and other conditions, but is preferably longer than 30 minutes. Too lengthy cross linking may greatly reduce tenacity, though.

The crosslinked PVA raw cord is washed and dried. To improve the adhesion to rubber, the dried raw cord is dipped in an resorcinol-formaline-latex (RFL) solution, dried, and thermally treated. Specifically, the dipping process is achieved by impregnating the fiber surface with the RFL solution, thereby improving adhesion to rubber.

An example dipping solution may be: resorcinol of 29.4 wt %—45.6 weight part; pure water—255.5 weight part; formalin of 37%—20 weight part; and sodium hydroxide of 10 wt %—3.8 weight part. The example dipping solution may be reacted at 25 degrees Celsius for 5 hours with stirring, and then added with the following components: VP-Latex of 40 wt %—300 weight part; pure water—129 weight part; and ammonia water of 28%—23.8 weight part. The solution containing the above components may be aged at 25 degrees Celsius for 20 hours and maintained at a solid concentration of 19.05%.

In order to prevent the RFL solution from infiltrating deeply into the inside of the fiber during the RFL dipping process, the raw cord is stretched to a stretch ratio of 0.5-3.0% and a dip pick up (DPU) of the RFL is 3.0-9.0 wt %. At a stretch ratio of less than 0.5%, DPU will exceed 9 wt % so that the RFL solution will be infiltrated deeply into the inside of the fiber and reduce fatigue resistance. At a stretch ratio of more than 3.0%, excessive tension will be applied to the raw cord and thus cause damage to the raw cord. Thermal treatment may be performed at a temperature of 170-230 degrees Celsius, and preferably 200-220 degrees Celsius, where the movement of PVA molecules is facilitated. Minimizing the tension applied to the fiber allows the greatest possible movement of the PVA molecules and maximizes heat treatment effect, thereby producing a treated high-tenacity PVA cord. In a heat treatment process, after dipping the raw cord in the RFL solution, the dipped cord is maintained at a stretch ratio of 0 to −5%. If the stretch ratio in the heat treatment process is above 0%, reduction of fatigue resistance may lead to cord cutting or separation in the carcassd ply 16. Conversely, at a stretch ratio below −5%, reduction in tenacity may lead to molecular recrystallization in a direction vertical to the fiber axis due to excessive molecular movement.

If the crosslinker solution is present within the fiber after the crosslinking process and water-washing process, the solution may act as an impurity in the tire 10. Thus, heat treatment is performed above 200 degrees Celsius such that the remaining crosslinker solution is reacted or volatilized to further improve crosslinking efficiency.

In the crosslinking described above, an example bobbin for crosslinking may comprise a first bobbin forming one portion of the crosslinking bobbin and a second bobbin detachably coupled to the first bobbin. In the first and second bobbins, hollows are formed, respectively. A plurality of through-holes are formed in circumferential portions of the first and second bobbins so that cylindrical bobbin axes, on which PVA raw cord is wound, are defined. In an inner end of the first and second bobbins, a coupling protrusion and a coupling groove correspond to each other such that the second bobbin is coupled to the first bobbin.

A first bobbin wheel is coupled to the first bobbin and closes the hollow of the bobbin for crosslinking. A second bobbin wheel is coupled to the second bobbin and connects with a crosslinker-feeding pipeline in order to supply a crosslinker into an interior of the wound PVA raw cord on a bobbin for crosslinking through the hollow formed in the bobbin by pressurizing or depressurizing.

The bobbin, on which the PVA raw cord was wound, is dipped in the crosslinker contained in a closed container charged with the crosslinker solution. The crosslinker is pressurized or depressurized to a specified pressure and supplied through the crosslinker-feeding pipeline. The supplied crosslinker is moved from inside to outside of the wound PVA raw cord through the through-holes formed in the respective bobbin axes or moved from the outside to inside of the PVA raw cord, so that the inside and outside of the wound PVA raw cord may be uniformly crosslinked.

As described above, the example crosslinked raw cord for use with the present invention is produced by the method comprising the steps of: twisting a 500-3000 deneir PVA drawn yarn to form a cabling yarn; plying the cabling yarn into a 2-ply or 3-ply yarn to form a raw cord; winding the raw cord on a bobbin for crosslinking; and crosslinking the wound raw cord in an aqueous crosslinking solution. The aqueous crosslinking solution contains an aromatic aldehyde compound, an acid catalyst, and alcohol. The resultant crosslinked raw cord may demonstrate excellent hot water resistance and may thus be suitable for use as a carcass ply for a light weight tire.

The previous language is of the best presently contemplated mode or modes of carrying out an example embodiment of the invention. This description is made for the purpose of illustrating the general principals of the invention and should not be taken in a limiting sense. The scope of the invention is best determined by reference to the appended claims.

What is claimed is:

1. A light weight pneumatic tire comprising:
a pair of parallel annular beads;
a carcass ply comprising a crosslinked polyvinyl alcohol raw cord;
a belt reinforcement structure disposed radially outward of the carcass ply in a crown area of the tire;
a tread disposed radially outward of the belt reinforcement structure; and
a pair of sidewalls disposed between the tread and the pair of beads, the polyvinyl alcohol crosslinked raw cord having a weight in the range of 1500 dtex to 2500 dtex.

2. The light weight pneumatic tire of claim 1 wherein the polyvinyl alcohol crosslinked raw cord has a degree of polymerization of 1,000-7,000 and a degree of saponification of more than 97 mol %, the polyvinyl alcohol being dissolved in dimethyl sulfoxide to form a solution, the solution being spun to form an undrawn yarn, the undrawn yarn being drawn to a high ratio and being thermally treated to form a drawn yarn, the drawn yarn being twisted and plied to form a raw cord, the raw cord being wound and crosslinked in an aqueous crosslinking solution comprising an aromatic aldehyde compound, an acid catalyst, and alcohol to form the crosslinked raw cord.

3. The light weight pneumatic tire of claim 2 wherein the aqueous cross linking solution
comprises methanol.

4. The light weight pneumatic tire of claim 2 wherein the alcohol of the aqueous crosslinking solution contains 1-30% weight.

5. The light weight pneumatic tire of claim 2 wherein the aromatic aldehyde compound is 0.1-5.0% weight.

6. The light weight pneumatic tire of claim 2 wherein the acid catalyst is acetic acid.

7. The light weight pneumatic tire of claim 2 wherein the polyvinyl alcohol crosslinked raw cord is dipped in an adhesive.

8. The light weight pneumatic tire of claim 7 wherein the adhesive is a resorcinol
formaldehyde latex.

9. The light weight pneumatic tire of claim 1 wherein the polyvinyl alcohol crosslinked raw cord has a construction of 1670 dtex/½.

10. The light weight pneumatic tire of claim 9 wherein the polyvinyl alcohol crosslinked raw
cord further has a 472Z×472S twist.

11. The light weight pneumatic tire of claim 1 wherein the polyvinyl alcohol crosslinked raw cord has a construction of 2200 dtex/½.

12. The light weight pneumatic tire of claim 11 wherein the polyvinyl alcohol crosslinked raw cord further has a 336Z×336S twist.
